(19) United States
(12) Patent Application Publication
(10) Pub. No.: US 2016/0207795 A1
(43) Pub. Date: Jul. 21, 2016

(54) ULTRAVIOLET STERILIZATION DEVICE

(71) Applicant: ASAHI ORGANIC CHEMICALS INDUSTRY CO., LTD., Nobeoka-shi, Miyazaki (JP)

(72) Inventor: Toshihiro HANADA, Nobeoka-shi, Miyazaki (JP)

(21) Appl. No.: 15/022,401

(22) PCT Filed: Sep. 18, 2014
(86) PCT No.: PCT/JP2014/074703

§ 371 Date: Mar. 16, 2016

(30) Foreign Application Priority Data
Sep. 24, 2013 (JP) 2013-197040

(51) Int. Cl. C02F 1/32

(52) U.S. Cl. CPC C02F 1/325; C02F 2201/3227; C02F 2201/3228; C02F 2201/326; C02F 2301/026; C02F 2303/04

(57) ABSTRACT

The present invention pertains to an ultraviolet sterilization device comprising: a transfer pipe (2) having an inlet port (4) and an outlet port (5); and an ultraviolet light source (3) that causes ultraviolet rays to be incident to the transfer pipe. Fluid to be treated that is inside the transfer pipe is sterilized by the ultraviolet rays irradiated from the ultraviolet light source. At least the inner peripheral surface of the transfer pipe is formed from a material having a smaller refractive index than the refractive index of the fluid to be treated that flows through the transfer pipe. The ultraviolet rays irradiated on the fluid to be treated are irradiated so as to be completely reflected by the inner peripheral surface of the transfer pipe.

### TECHNICAL FIELD

The present invention relates to an ultraviolet sterilization device which carries out sterilization or decomposition of bacteria, algae, impurities, etc. which are contained in a fluid to be processed by irradiation of ultraviolet rays so as to purify the fluid.

### BACKGROUND ART

In the past, as an ultraviolet sterilization device which is attached in the middle of a pipe and which carries out sterilization or photolysis of bacteria, algae, impurities, etc. contained in the fluid flowing through the pipe by irradiation of ultraviolet rays so as to purify the fluid, there has been the ultraviolet sterilization device 101 shown in FIG. 6 (for example, see PTL 1). The ultraviolet sterilization device 101 has an inlet port 102 and an outlet port 103 and is provided with a flow cell 105 which is configured so that the inside space becomes a channel 104, and one or more point light sources 106 which are arranged around the flow cell 105. A fluid to be processed can be sterilized by being irradiated by light emitted from the point light sources 106 toward the channel 104. At this time, if covering the inner circumferential surface of the flow cell 105 with a Lambert scattering material or other scattering material 107 etc., the irradiated light is scattered, so the irradiated light can effectively irradiate the fluid to be processed. Further, if arranging a baffle 108 inside the flow cell 105, a flow is generated inside the flow cell 105, so the the residence time can be increased and the irradiated light can effectively irradiate the fluid to be processed.

### CITATION LIST

### Patent Literature

PTL 1: Japanese Patent Publication No. 2012-512723A

### SUMMARY OF INVENTION

### Technical Problem

However, the conventional ultraviolet sterilization device 101 scatters the irradiated light by the scattering member 107, so the irradiated light is attenuated with each scattering action. For this reason, in order to effectively sterilize a fluid to be processed, a large number of point light sources 106 are necessary. Further, if making the volume of the flow cell 105 larger to ensure the fluid to be processed has sufficient residence time in the flow cell 105, spaces which are hard for the irradiated light to reach (referred to as called “dead spaces”, below) easily form in the flow cell 105 and the fluid to be processed may be hard for the light to uniformly irradiate. By arranging a baffle 108 inside the flow cell 105, increasing the residence time of the fluid to be processed and uniformly irradiating the fluid to be processed with irradiated light become easy, but the structure may be complicated, so the assembly work or the maintenance work may be troublesome. Further, since a large number of point light sources 106 are necessary, not only does the assembly work become troublesome, but also frequent maintenance work becomes necessary to maintain the sterilizing effect.

The present invention was made in consideration of such a problem in the prior art and has as its object the provision of an ultraviolet sterilization device which enables ultraviolet rays to be reflected with almost no attenuation when ultraviolet rays are reflected at the pipeline inner circumferential surface and as a result which can effectively irradiate a fluid to be processed with ultraviolet rays even by a smaller number of ultraviolet light sources.

### Solution to Problem

According to the aspect of the invention of claim 1, there is provided an ultraviolet sterilization device comprising a transport pipe which has an inlet opening and an outlet opening and an ultraviolet light source which emits ultraviolet rays to the transport pipe, for sterilizing a fluid to be processed in the transport pipe by ultraviolet rays emitted from the ultraviolet light source, wherein at least an inner circumferential surface of the transport pipe is formed from a material which has a refractive index smaller than a refractive index of the fluid to be processed which flows through the transport pipe and ultraviolet rays which are irradiated to the fluid to be processed are totally reflected at the inner circumferential surface of the transport pipe.

That is, in the aspect of the invention of claim 1, the inner circumferential surface of the transport pipe is formed from a material which has a smaller refractive index than the refractive index of the fluid to be processed which flows through the transport pipe and the ultraviolet rays emitted from the ultraviolet light source to the fluid to be processed are totally reflected at the inner circumferential surface of the transport pipe, so the ultraviolet rays which are emitted to the inside of the transport pipe are totally reflected when reflected at the inner circumferential surface of the transport pipe. Therefore, even if the number of times in which the ultraviolet rays are reflected at the inner circumferential surface of the transport pipe increases, attenuation of the ultraviolet rays can be suppressed and the fluid to be processed can be effectively sterilized. Further, since the ultraviolet rays are totally reflected at the inner circumferential surface of the channel, the irradiated ultraviolet rays can be propagated far, so the shape of the transport pipe can be made a shape with a small channel cross-sectional area and with a long channel length. By making the shape of the transport pipe a shape with a small channel cross-sectional area and with a long channel length, it becomes harder to form spaces difficult for ultraviolet rays to irradiate (dead spaces) inside the transport pipe and it is possible to make the residence time of the fluid to be processed longer.

Further, since the ultraviolet rays are totally reflected at the inner circumferential surface of the transport pipe, the number of times of reflections of ultraviolet rays per ultraviolet light source can be increased, so the number of ultraviolet light sources can be reduced and the assembly work and maintenance work of the ultraviolet sterilization device become easier.

According to the aspect of the invention of claim 2, there is provided an ultraviolet sterilization device according to claim 1 wherein at least an inner circumferential surface of the transport pipe is formed from a material which has a refractive index smaller than a refractive index of water with respect to ultraviolet rays which are emitted from the ultraviolet light source.

That is, in the aspect of the invention of claim 2, since the refractive index of the inner circumferential surface of the transport pipe is smaller than the refractive index of water with respect to ultraviolet rays which are emitted from the ultraviolet light source, it is possible to effectively sterilize various types of diverse fluids to be processed with small refractive indexes such as water. Note that, the refractive index of water with respect to ultraviolet rays is, for example, a refractive index of 1.54 at a wavelength of 185 nm, a refractive index of 1.51 at a wavelength of 215 nm, a refractive index of 1.49 at a wavelength of 280 nm, and a refractive index of 1.47 at a wavelength of 305 nm.

According to the aspect of the invention of claim 3, there is provided an ultraviolet sterilization device according to claim 1 or 2 wherein the ultraviolet light source is provided at least at either end part of an inlet opening or outlet opening of the transport pipe.

That is, in the aspect of the invention of claim 3, by arranging the ultraviolet light source at an end part of the transport pipe, it is possible to make the ultraviolet rays reach positions farther from the ultraviolet light source than when arranging the ultraviolet light source at another location.

According to the aspect of the invention of claim 4, there is provided an ultraviolet sterilization device according to any one of claims 1 to 3 wherein the transport pipe is formed from an amorphous fluororesin.

That is, in the aspect of the invention of claim 4, since the transport pipe is formed from an amorphous fluororesin which is a material with a particularly low refractive index, the attenuation of the ultraviolet rays which occurs when the ultraviolet rays are reflected at the inner circumferential surface of the transport pipe can be greatly suppressed.

According to the aspect of the invention of claim 5, there is provided an ultraviolet sterilization device according to any one of claims 1 to 3 wherein an inner circumferential surface of the transport pipe is covered with an amorphous fluororesin.

That is, in the aspect of the invention of claim 5, by covering the inner circumferential surface of the transport pipe with an amorphous fluororesin which is a material with a particularly low refractive index, it is possible to suitably select as the material of the transport pipe a material which meets the pressure and other various conditions of the fluid to be processed.

According to the aspect of the invention of claim 6, there is provided an ultraviolet sterilization device according to any one of claims 1 to 5 wherein the transport pipe is formed in a spiral shape.

That is, in the aspect of the invention of claim 6, the channel of the transport pipe is formed in a spiral shape, so the channel of the transport pipe can be made longer, the shape of the transport pipe can be made compact, and the residence time of the fluid to be processed can be lengthened. If forming the channel in a spiral shape so as to reduce the channel cross-sectional area of the channel of the transport pipe and lengthen the channel, it is possible to provide an ultraviolet sterilization device with little dead spaces, with ultraviolet rays uniformly irradiated, and further with a long residence time of the fluid to be processed.

According to the aspect of the invention of claim 7, there is provided an ultraviolet sterilization device according to any one of claims 1 to 6, comprising a plurality of the transport pipes, upstream side branch pipes which are respectively connected to inlet openings of the transport pipes, and downstream side branch pipes which are respectively connected to outlet openings of the transport pipes, wherein a plurality of the ultraviolet light sources are provided at least at either the upstream side branch pipes or the downstream side branch pipes so that ultraviolet rays enter all of the transport pipes.

That is, in the aspect of the invention of claim 7, since the fluid to be processed is branched and then the branched fluids to be processed flow into a plurality of transport pipes, it is possible to simultaneously treat fluid to be processed divided into small amounts, so it is possible to provide an ultraviolet sterilization device which can effectively irradiate fluid to be processed with ultraviolet rays.

According to the aspect of the invention of claim 8, there is provided an ultraviolet sterilization device according to any one of claims 1 to 7 wherein an ultraviolet ray intensity measuring device which measures an intensity of ultraviolet rays which are emitted from the ultraviolet light source is provided at the transport pipe and a control part which controls the intensity of ultraviolet rays of the ultraviolet light source based on a measured value of the ultraviolet ray intensity measuring device is provided.

That is, in the aspect of the invention of claim 8, by providing the transport pipe with an ultraviolet ray intensity measuring device and control part, it is possible to measure the intensity of ultraviolet rays at a predetermined position of the transport pipe and possible to change the intensity of the ultraviolet rays based on measured values thereof. Due to this, it is possible to effectively irradiate a fluid to be processed with ultraviolet rays in accordance with various circumstances such as the state of contamination of the fluid to be processed or the extent of sterilization treatment.

### Advantageous Effects of the Invention

According to the aspects of the invention according to claim 1 to claim 8, it is possible to totally reflect the ultraviolet rays at a pipeline inner circumferential surface, so it is possible to provide an ultraviolet sterilization device which can effectively irradiate a fluid to be processed with ultraviolet rays by a smaller number of ultraviolet light sources.

### BRIEF DESCRIPTION OF THE DRAWINGS

FIG. 1 is a longitudinal section view which shows an ultraviolet sterilization device according to a first embodiment of the present invention.

FIG. 2 is a longitudinal section view which shows an ultraviolet sterilization device according to a second embodiment of the present invention.

FIG. 3 is a partial section front view which shows an ultraviolet sterilization device according to a third embodiment of the present invention.

FIG. 4 is a longitudinal section view which shows an ultraviolet sterilization device according to a fourth embodiment of the present invention.

FIG. 5 is a partial section front view which shows an ultraviolet sterilization device according to a fifth embodiment of the present invention.

FIG. 6 is a longitudinal section view which shows a conventional ultraviolet sterilization device.

### DESCRIPTION OF EMBODIMENTS

Below, embodiments of the present invention will be explained with reference to the drawings, but the present invention is not limited to the following embodiments needless to say.

### First Embodiment

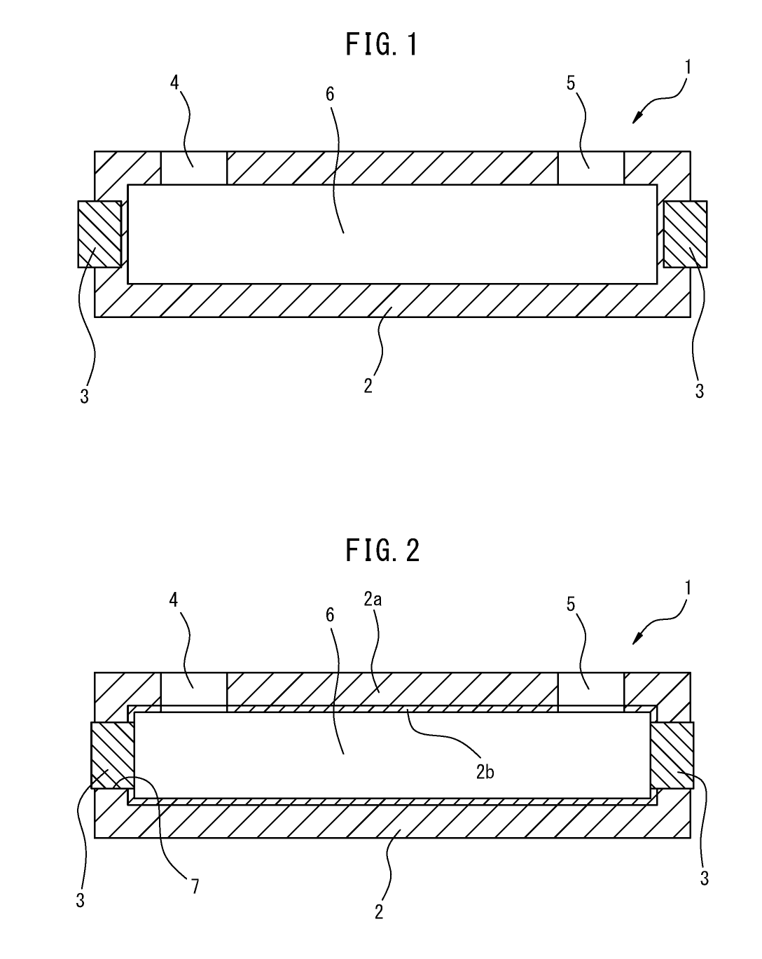

Below, referring to FIG. 1, an ultraviolet sterilization device 1 according to a first embodiment of the present invention will be explained. FIG. 1 is a longitudinal section view which shows an ultraviolet sterilization device 1 according to the first embodiment. This ultraviolet sterilization device 1 is provided with a transport pipe 2 which has an inlet opening 4 and an outlet opening 5, and ultraviolet light sources 3. Further, at least the inner circumferential surface of the transport pipe 2 is formed from a material which has a smaller refractive index than the refractive index of the fluid to be processed which flows through the transport pipe 2. Further, the ultraviolet rays which are emitted from the ultraviolet light sources to the fluid to be processed are emitted to be totally reflected at the inner circumferential surface of the transport pipe.

In the first embodiment, the transport pipe 2 is made of amorphous fluororesin, has a circular cross-sectional shape, and is formed into a straight tubular shape. The two end faces of the transport pipe 2 are closed. At one end part of the transport pipe 2, there is an inlet opening 4 which is formed perpendicular to the transport pipe 2, while at the other end part of the transport pipe 2, there is an outlet opening 5 which is formed perpendicular to the transport pipe 2. At the inlet opening 4 and outlet opening 5, pipes are connected to the front and back of the ultraviolet sterilization device 1. At the inside of the transport pipe 2, a channel 6 is formed which transports, for example, drinking water as a fluid to be processed.

In the present invention, in terms of the material of the transport pipe 2, at least the material of the inner circumferential surface of the transport pipe 2 should be a material which has a smaller refractive index than the refractive index of the fluid to be processed which flows through the channel 6. That is, it is also possible that only the inner circumferential surface of the transport pipe 2 is formed by a material which has a refractive index smaller than the refractive index of the fluid to be processed. When forming only the inner circumferential surface of the transport pipe 2 by a material which has a refractive index smaller than the refractive index of the fluid to be processed by means of covering or another method, the material of the transport pipe 2 other than the inner circumferential surface is not particularly limited. It is possible to suitably select the material of the transport pipe 2 other than the inner circumferential surface in accordance with the environment of use of the ultraviolet sterilization device 1, the conditions of formation of the covering, etc. As another small refractive index material other than an amorphous fluororesin, for example, polymethyl methacrylate, polypropylene, polyvinylidene fluoride or other fluororesin, gold, silver, copper, or other material may be mentioned.

In the present invention, the cross-sectional shape of the transport pipe 2 is not particularly limited, but if considering the ultraviolet rays being effectively reflected at inner circumferential surface of the channel 6, the productivity, etc., the cross-sectional shape is preferably a circular shape. Further, in the present invention, the external shape of the transport pipe 2 is not particularly limited. As the external shape of the transport pipe 2, in addition to a straight tubular shape, a straight tubular shape where the center part is enlarged compared with the two end parts, a curved tubular shape, etc. may be mentioned. If closing the end part of the straight tubular shaped transport pipe 2 and forming the inlet opening 4 and outlet opening 5 at the side faces of the transport pipe 2 so as to be perpendicular to the transport pipe 2, attachment of the ultraviolet light sources 3 to the end parts of the transport pipe 2 becomes easy, so this is particularly preferred.

In the first embodiment, light emitting diodes which emit ultraviolet rays are used for the ultraviolet light sources 3. The ultraviolet light sources 3 are arranged at the two end parts of the transport pipe 2 so that the ultraviolet light sources 3 are not exposed at the channel 6. By the ultraviolet light sources 3 being arranged so as not to be exposed at the channel 6, it is possible to prevent relief shapes from being formed at the inner circumferential surface of the channel 6 and prevent the surfaces of the ultraviolet light sources 3 and the inside surface of the transport pipe 2 from being fouled. Further, since the ultraviolet light sources 3 are arranged so as not to be exposed at the channel 6, there is no liability of leakage of fluid to be processed to the outside of the transport pipe 2, breakage of the ultraviolet light sources 3 inside of the channel 6, etc. and the assembly work and maintenance work of the ultraviolet sterilization device 1 can be facilitated. Further, the ultraviolet light sources 3 are arranged so that the ultraviolet rays which irradiate the fluid to be processed are totally reflected at the inner circumferential surface of the transport pipe 2. In order to make the ultraviolet rays be totally reflected at the inner circumferential surface of the transport pipe 2, it is necessary to emit the ultraviolet rays so that, when the ultraviolet rays enter the inner circumferential surface of the transport pipe 2, the incidence angle is larger than the critical angle. Further, the ultraviolet light sources 3 are arranged so that the light emitting faces of the ultraviolet light sources 3 and the transport pipe 2 abut in order to suppress attenuation of the ultraviolet rays when the ultraviolet rays enter the channel 6.

The type and wavelength of the ultraviolet light sources 3 can be suitably selected by the object of use of the ultraviolet sterilization device 1. As the type of the ultraviolet light source 3, in addition to light emitting diodes which emit ultraviolet rays, ultraviolet lamps, excimer lasers, etc., may be mentioned as suitable. Further, as the wavelength of the ultraviolet rays, if considering the sterilizing effect, light sources which emit ultraviolet rays of a wavelength between 150 to 400 nm, preferably between 200 to 400 nm are preferable. Further, different types or different wavelengths of ultraviolet light sources 3 may also be used together.

In the present invention, the locations for arranging the ultraviolet light sources 3 are not particularly limited. In the first embodiment, the ultraviolet light sources 3 are arranged at the two end parts of the transport pipe 2, but a light source may also be arranged at just one end part of the transport pipe 2. Further, in the first embodiment, the ultraviolet light sources 3 are arranged so as not to be exposed at the channel 6, but in order to suppress attenuation of ultraviolet rays as much as possible, the ultraviolet light sources 3 can also be arranged so as to be exposed in the channel 6. The invention is not particularly limited thereto.

Next, the technical advantages of the ultraviolet sterilization device 1 of the first embodiment of the present invention will be explained.

When the transport pipe 2 through which the fluid to be processed of drinking water is transported is irradiated by ultraviolet rays from the ultraviolet light sources 3 which are arranged at the two end parts of the transport pipe 2, the ultraviolet rays pass through the transport pipe 2 and enter the channel 6. At this time, the transport pipe 2 is formed by an amorphous fluororesin with an extremely small refractive index, 1.31. The refractive index of the inner circumferential surface of the transport pipe 2 is smaller than the refractive index of the fluid to be processed of drinking water which flows through the transport pipe 2. Further, the ultraviolet light sources 3 are arranged so that when the ultraviolet rays enter the inner circumferential surface of the transport pipe 2, the incidence angle is larger than the critical angle. By configuring the transport pipe 2 and the ultraviolet light sources 3 in this way, the ultraviolet rays which enter the channel 6 are totally reflected when reaching the inner circumferential surface of the transport pipe 2. The ultraviolet rays which are reflected by the inner circumferential surface of the transport pipe 2 are totally reflected again at another location of the inner circumferential surface of the transport pipe 2. In this way, the ultraviolet rays are repeatedly totally reflected inside the channel 6 while proceeding therein from the upstream side toward the downstream side or from the downstream side toward the upstream side. When the ultraviolet rays proceed through the inside of the channel 6, when the ultraviolet rays irradiate the bacteria, etc., in the fluid to be processed, the fluid to be processed is sterilized.

The ultraviolet rays which enter the channel 6 are totally reflected at the inner circumferential surface of the transport pipe 2, so even if the number of times the ultraviolet rays are reflected at the inner circumferential surface of the transport pipe 2 increases, it is possible to suppress attenuation of the ultraviolet rays and possible to effectively sterilize the fluid to be processed. Further, by forming the inner circumferential surface of the transport pipe 2 from amorphous fluororesin, water and other of many types of liquids can be effectively sterilized.

Further, since the ultraviolet rays are totally reflected, the ultraviolet rays can reach positions far from the ultraviolet light sources 3. Since the distance which the ultraviolet rays reach is long, even if the shape of the transport pipe 2 is made a shape with a small channel cross-sectional area and long channel length, the inside of the channel 6 can be effectively irradiated with ultraviolet rays. By making the shape of the transport pipe 2 a shape with a small channel cross-sectional area and long channel length, the dead spaces can be made smaller and the fluid to be processed can be increased in time of residence in the transport pipe 2. Further, since the distance which the ultraviolet rays reach is long, the dead spaces can be reduced while a broad range can be irradiated by ultraviolet rays.

### Second Embodiment

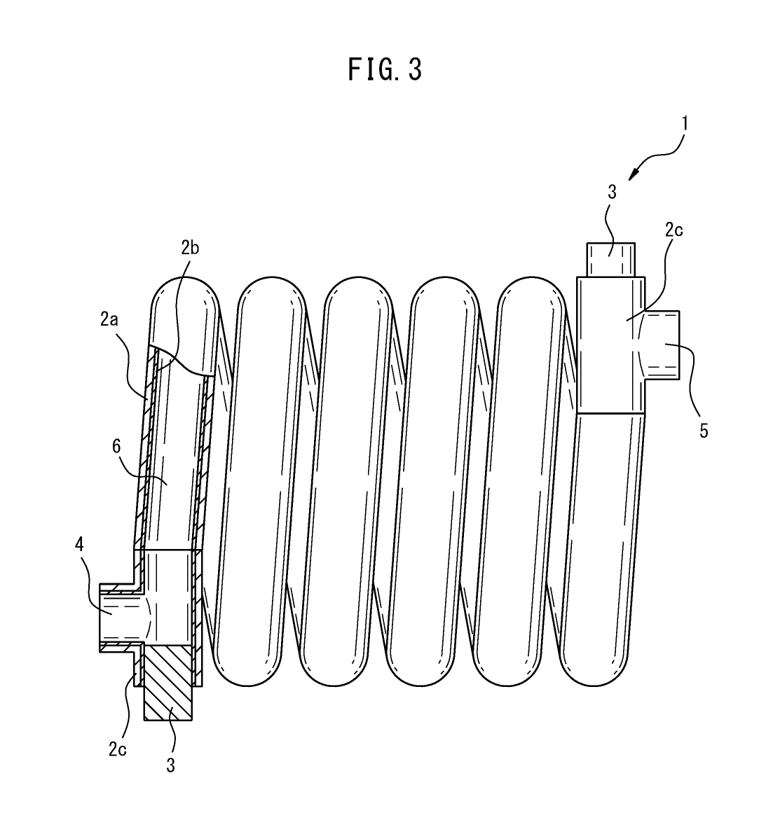

Below, referring to FIG. 2, an ultraviolet sterilization device 1 according to a second embodiment of the present invention will be explained. FIG. 2 is a longitudinal section view which shows an ultraviolet sterilization device 1 according to the second embodiment. The point by which the second embodiment differs from the first embodiment is mainly the provision of the covering layer 2b on the inner circumferential surface of the transport pipe 2. Note that, in FIG. 2, components which have similar operations or functions as the first embodiment are assigned the same reference notations as in FIG. 1. Below, mainly the points of difference from the first embodiment will be explained.

The header 2a of the transport pipe 2 is made of stainless steel and the inner circumferential surface of the transport pipe 2 is covered with an amorphous fluororesin to form a covering layer 2b. At the two end parts of the transport pipe 2, through holes 7 are provided from the two end faces of the transport pipe 2 to the channel 6. At the through holes 7, ultraviolet light sources 3 are attached in a watertight state. The light emitting faces of the ultraviolet light sources 3 are exposed at the inside of the channel 6.

As the method of forming a covering layer 2b at the inner circumferential surface of the transport pipe 2, the method of applying a coating to the inner circumferential surface so as to form a film, the method of bonding a tubular member comprised of a rigid material to form an integral piece, etc., may be mentioned, but the invention is not particularly limited thereto. In the second embodiment, the inner circumferential surface of the transport pipe 2 is pretreated, and then a coating solution obtained by dissolving an amorphous fluororesin in a solvent is coated on the inner circumferential surface of the transport pipe 2 whereby a covering layer 2b is formed.

In the second embodiment, the rest of the configurations of the ultraviolet sterilization device 1 is similar to the configurations in the first embodiment, so the explanation thereof will be omitted. The operation by which ultraviolet rays are reflected in the channel 6 of the second embodiment and irradiate the fluid to be processed is similar to the first embodiment, so the explanation will be omitted.

### Third Embodiment

Below, referring to FIG. 3, an ultraviolet sterilization device 1 according to a third embodiment of the present invention will be explained. FIG. 3 is a partial section front view which shows an ultraviolet sterilization device 1 according to the third embodiment. The point by which the third embodiment differs from the first embodiment is mainly the shape of the channel 6. That is, in the third embodiment, the channel 6 of the transport pipe 2 is formed in a spiral shape. Note that, in FIG. 3, components which have similar operations or functions as the first embodiment are assigned the same reference notations as in FIG. 1. Below, mainly the points of difference from the first embodiment will be explained.

The transport pipe 2 is provided with a header 2a which is a circular cross-section tube formed in a spiral shape and made of stainless steel, and with joints 2c which are made of stainless steel and connected to the two ends of the header 2a. The channel cross-sectional area of the header 2a is an area sufficiently smaller compared with the length of the header 2a along the channel axis. The inner circumferential surface of the transport pipe 2 is formed with a covering layer 2b of a film made of an amorphous fluororesin. The joints 2c are connected to the two end parts of the header 2a and are formed by T-shaped members having openings in three directions. The joints 2c are respectively disposed with ultraviolet light sources 3. At one of the openings of each joint 2c, an ultraviolet light source 3 is attached in a watertight state. At the opening facing the opening at which the ultraviolet light source 3 is attached, the header 2a is connected. The remaining opening becomes the inlet opening 4 or outlet opening 5.

Next, the technical advantages of the ultraviolet sterilization device 1 according to the third embodiment of the present invention will be explained.

The fluid to be processed of drinking water flows from the inlet opening 4 of the joint 2c to the transport pipe 2, passes through the inside of the joint 2c, and flows into the header 2a. At this time, in the joint 2c, the ultraviolet light source 3 is arranged so that the angle of the ultraviolet rays entering the inner circumferential surface of the channel 6 is an angle where they are totally reflected at the inner circumferential surface of the channel 6. The fluid to be processed flowing into the header 2a is irradiated by these ultraviolet rays. The ultraviolet rays are repeatedly reflected at the inner circumferential surface of the transport pipe 2 while proceeding through the channel 6. At this time, the ultraviolet rays are totally reflected, so attenuation of the ultraviolet rays by reflection can be suppressed and ultraviolet rays can be made to reach a position further from the ultraviolet light source 3. The fluid to be processed flowing into the header 2a flows in the channel 6 to the downstream side. Here, since the header 2a is formed in a spiral shape, the channel 6 can be made longer. As a result, the residence time of the fluid to be processed in the channel 6 becomes longer, so the fluid to be processed can be effectively irradiated by the ultraviolet rays. Further, since the channel 6 is formed in a spiral shape, even if the channel 6 is made longer, the shape of the transport pipe 2 can be formed compactly. Further, since the ultraviolet light source 3 is arranged at the end part of the transport pipe 2, the ultraviolet rays can be made to reach far in the channel 6. Further, the channel cross-sectional area of the channel 6 is sufficiently smaller than the length of the channel 6, so the dead spaces can be made smaller and the ultraviolet rays can more effectively irradiate the fluid to be processed. The fluid to be processed which flows downstream through the channel 6 flows out from the outlet opening 5 of the downstream side joint 2c to the outside of the transport pipe 2. At this time, since an ultraviolet light source 3 is also arranged at the downstream side joint 2c, the ultraviolet rays can effectively irradiate the fluid to be processed.

### Fourth Embodiment

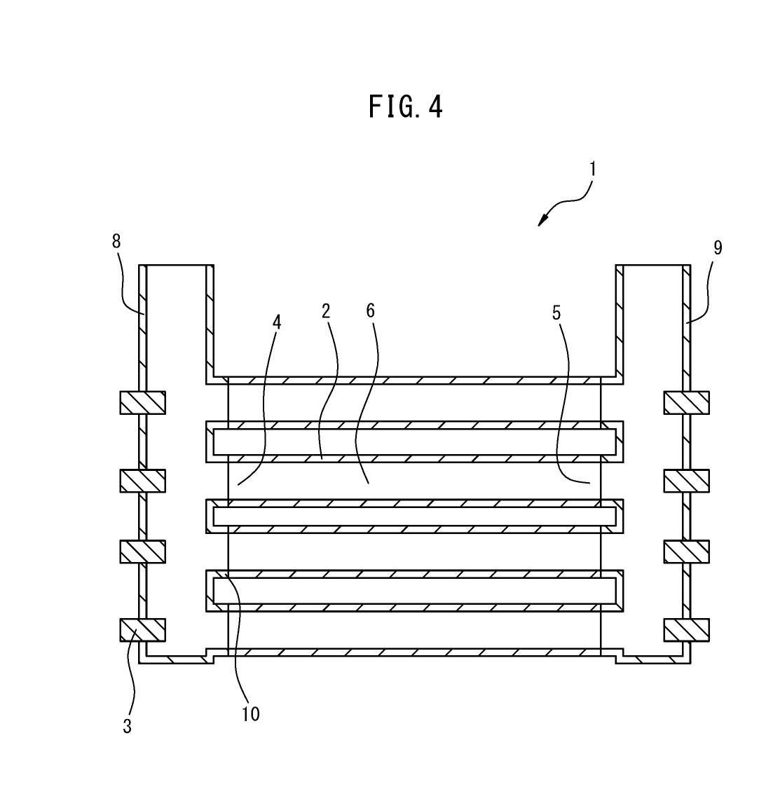

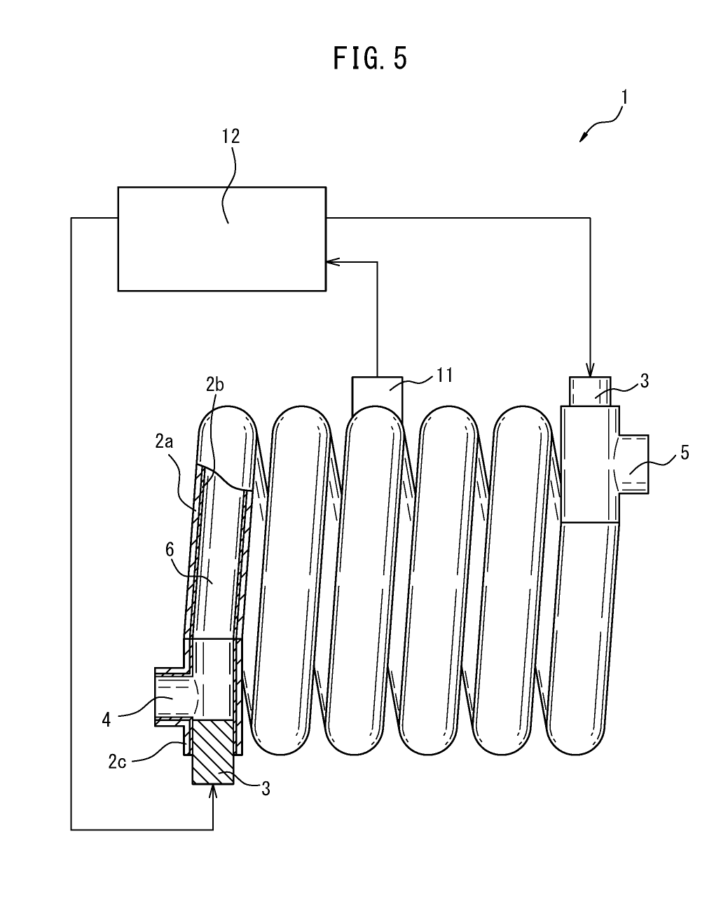

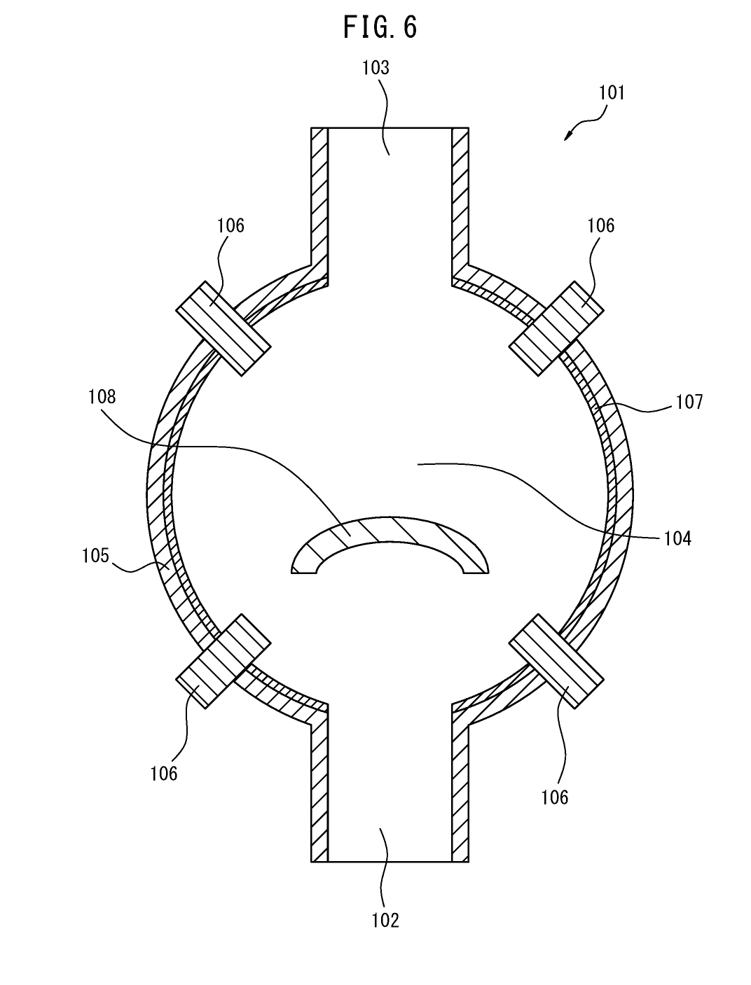

Below, referring to FIG. 4, the ultraviolet sterilization device 1 according to the fourth embodiment of the present invention will be explained. FIG. 4 is a longitudinal section view which shows an ultraviolet sterilization device 1 according to the fourth embodiment. The point by which fourth embodiment differs from the first embodiment is mainly the treatment of the fluid to be processed at a plurality of the transport pipes 2. That is, in the fourth embodiment, an upstream side branch pipe 8 and a downstream side branch pipe 9 are arranged before and after the transport pipes 2, so the fluid to be processed is branched and flows to the plurality of the transport pipes 2. Note that, in FIG. 4, components which have similar operations or functions as the first embodiment are assigned the same reference notations as in FIG. 1. Below, mainly the points of difference from the first embodiment will be explained.

In the fourth embodiment, the transport pipes 2 are made of an amorphous fluororesin, have circular cross-sectional shapes, and are formed into straight tubular shapes. At the two end faces of the transport pipes 2, inlet openings 4 and outlet openings 5 are formed. The end parts of the transport pipes 2 at the inlet opening 4 sides are connected to the upstream side branch pipe 8 which is arranged at the upstream sides of the transport pipes 2, while the end parts at the outlet opening 5 sides are connected to the downstream side branch pipe 9 which is arranged at the downstream sides of the transport pipes 2.

In the fourth embodiment, the upstream side branch pipe 8 and the downstream side branch pipe 9 are formed to the same shapes. Therefore, below, mainly the upstream side branch pipe 8 will be explained as a representative thereof. The upstream side branch pipe 8 is made of an amorphous fluororesin, has a circular cross-sectional shape, and is formed into straight tubular shapes. One end face of the upstream side branch pipe 8 is formed with an opening, but the other end face is closed. At the side face of the upstream side branch pipe 8, a plurality of branch parts 10 which stick out in a direction perpendicular to the channel axis of the upstream side branch pipe 8 are provided in straight shapes. The transport pipes 2 are respectively connected to the branch parts 10. Further, at the side face of the upstream side branch pipe 8, a plurality of ultraviolet light sources 3 are arranged. In the fourth embodiment, the upstream side branch pipe 8 and downstream side branch pipe 9 are formed in straight tubular shapes, but they may be formed in circular shapes or rectangular shapes. The shapes thereof are not particularly limited. Further, in the fourth embodiment, the branch parts 10 and the transport pipes 2 are arranged in straight lines, but the invention is not particularly limited thereto. For example, the branch parts 10 and the transport pipes 2 may be arranged so as to form circular shaped bundles. The cross-sectional shapes thereof may also be hexagonal shapes arranged in the form of a honeycomb. Further, in the fourth embodiment, a plurality of the transport pipes 2 are individually formed, but they may also be formed integrally. The invention is not particularly limited thereto.

The ultraviolet light sources 3 are arranged so that ultraviolet rays enter all of the transport pipes 2 and the ultraviolet rays enter at angles by which they are totally reflected at the inner circumferential surfaces of the transport pipes 2. In the fourth embodiment, ultraviolet light sources 3 are arranged for each transport pipe 2, and the ultraviolet light sources 3 are arranged at both of the upstream side branch pipe 8 and the downstream side branch pipe 9. However, it is sufficient that the ultraviolet light sources 3 are arranged at least at one of the upstream side branch pipe 8 and downstream side branch pipe 9. In the fourth embodiment, the rest of the configuration of the ultraviolet sterilization device 1 is similar to the configuration in the first embodiment, so the explanation thereof will be omitted.

Next, the technical advantages of the ultraviolet sterilization device 1 according to the fourth embodiment of the present invention will be explained.

The drinking water of the fluid to be processed in the fourth embodiment flows into the upstream side branch pipe 8. The inflowing fluid to be processed is branched at the branch parts 10. The branched fluids to be processed flow into the transport pipes 2. At this time, at the upstream side branch pipe 8, ultraviolet light sources 3 are arranged so that the ultraviolet rays are totally reflected at the inner circumferential surfaces of the transport pipes 2. The ultraviolet rays which are emitted from the ultraviolet light sources 3 to the transport pipes 2 are repeatedly totally reflected at the inner circumferential surfaces of the transport pipes 2 while proceeding through the inside of the channels 6 and irradiate the fluid to be processed. Further, in the same way as the upstream side branch pipe 8, ultraviolet light sources 3 are arranged at the downstream side branch pipe 9. Ultraviolet rays are irradiated over the fluid to be processed from the downstream sides of the transport pipes 2. Further, in the fourth embodiment, since the fluid to be processed is branched at the upstream side branch pipe 8 and the branched fluids to be processed are made to flow into the plurality of the transport pipes 2, it is possible to effectively irradiate the fluid to be processed by the ultraviolet rays.

### Fifth Embodiment

Below, referring to FIG. 5, an ultraviolet sterilization device 1 according to a fifth embodiment of the present invention will be explained. FIG. 5 is a partial section front view which shows an ultraviolet sterilization device 1 according to the fifth embodiment. The points by which the fifth embodiment differs from the third embodiment are mainly the configurations of the ultraviolet ray intensity measuring device 11 and the control part 12 which controls the intensity of the ultraviolet rays. That is, in the fifth embodiment, the ultraviolet ray intensity measuring device 11 for measuring the intensity of the ultraviolet rays which are emitted from the ultraviolet light sources 3 is provided at the transport pipe 2. The control part 12 for controlling the intensity of the ultraviolet rays based on the measured value of the ultraviolet ray intensity measuring device 11 is provided. Note that, in FIG. 5, components which have similar operations or functions as the third embodiment are assigned the same reference notations as in FIG. 3. Below, mainly the points of difference from the third embodiment will be explained.

The ultraviolet ray intensity measuring device 11 is arranged at the middle part of the channel 6 of the transport pipe 2. The ultraviolet ray intensity measuring device 11 can measure the intensity of the ultraviolet rays in the channel 6 at the location of arrangement of the ultraviolet ray intensity measuring device 11, without stopping the flow of the fluid to be processed. Further, the control part 12, which is a different object from the transport pipe 2, is arranged thereon. The control part 12 is connected to the ultraviolet ray intensity measuring device 11 and the ultraviolet light source 3. The control part 12 can change the intensity and irradiation time of the ultraviolet rays emitted from the ultraviolet light source 3, based on electric signals for transmitting measured values from the ultraviolet ray intensity measuring device 11. In the fifth embodiment, the rest of the configuration of the ultraviolet sterilization device 1 is similar to the configuration in the third embodiment, so the explanation thereof will be omitted.

Next, the technical advantages of the ultraviolet sterilization device 1 according to the fifth embodiment of the present invention will be explained using FIG. 5.

The fluid to be processed which flows into the transport pipe 2 flows through the channel 6 to the downstream side and reaches the middle part of the channel 6. At the middle part of the channel 6, the ultraviolet ray intensity measuring device 11 is arranged. The ultraviolet ray intensity measuring device 11 is used to measure the intensity of ultraviolet rays at the middle part of the channel 6. The intensity of the ultraviolet rays measured by the ultraviolet ray intensity measuring device 11 is converted to an electric signal and output to the control part 12. The control part 12 outputs signals to the ultraviolet light sources 3 so that the difference of the intensity of the ultraviolet rays measured in real time from the arbitrarily defined intensity of ultraviolet rays is zero. The ultraviolet light sources 3 change the intensity of the ultraviolet rays in accordance with the signals received from the control part 12. By the configuration of the ultraviolet sterilization device 1 in this way, the ultraviolet rays in the channel 6 of the ultraviolet sterilization device 1 can be kept at a predetermined intensity, so it is possible to effectively sterilize the fluid to be processed. The operation of irradiating the fluid to be processed by ultraviolet rays in the ultraviolet sterilization device 1 according to the fifth embodiment is similar to the third embodiment, so an explanation thereof will be omitted. Further, in the fifth embodiment, the ultraviolet ray intensity measuring device 11 is arranged at only one location, but a plurality of ultraviolet ray intensity measuring devices 11 may also be arranged. The invention is not particularly limited thereto.

In the present invention, a plurality of ultraviolet sterilization devices 1 may be connected in series. By connecting a plurality of ultraviolet sterilization devices 1 in series, it is possible to make the treatment time of the fluid to be processed longer. At this time, it is also possible to change the wavelengths of the ultraviolet light sources 3 of the ultraviolet sterilization devices 1.

Note that, the ultraviolet sterilization devices 1 of the first embodiment to the fifth embodiment can be freely combined to form an ultraviolet sterilization device. That is, so long as the features and functions of the present invention can be realized, the present invention is not limited to the ultraviolet sterilization devices 1 of the embodiments.

### REFERENCE NOTATIONS LIST

1. ultraviolet sterilization device
2. transport pipe
2a. header
2b. covering layer
2c. joint
3. ultraviolet light source
4. inlet opening
5. outlet opening
6. channel
7. through hole
8. upstream side branch pipe
9. downstream side branch pipe
10. branch part
11. ultraviolet ray intensity measuring device
12. control part

1. An ultraviolet sterilization device comprising a transport pipe which has an inlet opening and an outlet opening and an ultraviolet light source which emits ultraviolet rays to the transport pipe, for sterilizing a fluid to be processed in the transport pipe by ultraviolet rays emitted from the ultraviolet light source, wherein
at least an inner circumferential surface of the transport pipe is formed from a material which has a refractive index smaller than a refractive index of the fluid to be processed which flows through the transport pipe, and
ultraviolet rays which are irradiated to the fluid to be processed are totally reflected at the inner circumferential surface of the transport pipe.

2. The ultraviolet sterilization device according to claim 1
wherein at least an inner circumferential surface of the transport pipe is formed from a material which has a refractive index smaller than a refractive index of water with respect to ultraviolet rays which are emitted from the ultraviolet light source.

3. The ultraviolet sterilization device according to claim 1, wherein the ultraviolet light source is provided at least at either end part of an inlet opening or outlet opening of the transport pipe.

4. The ultraviolet sterilization device according to claim 1, wherein the transport pipe is formed from an amorphous fluororesin.

5. The ultraviolet sterilization device according to claim 1, wherein an inner circumferential surface of the transport pipe is covered with an amorphous fluororesin.

6. The ultraviolet sterilization device according to claim 1, wherein the transport pipe is formed in a spiral shape.

7. The ultraviolet sterilization device according to claim 1, comprising a plurality of the transport pipes, upstream side branch pipes which are respectively connected to inlet openings of the transport pipes, and downstream side branch pipes which are respectively connected to outlet openings of the transport pipes, wherein
a plurality of the ultraviolet light sources are provided at least at either the upstream side branch pipes or the downstream side branch pipes so that ultraviolet rays enter all of the transport pipes.

8. The ultraviolet sterilization device according to claim 1, wherein
an ultraviolet ray intensity measuring device which measures an intensity of ultraviolet rays which are emitted from the ultraviolet light source is provided at the transport pipe and
a control part which controls the intensity of ultraviolet rays of the ultraviolet light source based on a measured value of the ultraviolet ray intensity measuring device is provided.

9. The ultraviolet sterilization device according to claim 2, wherein the ultraviolet light source is provided at least at either end part of an inlet opening or outlet opening of the transport pipe.

10. The ultraviolet sterilization device according to claim 2, wherein the transport pipe is formed in a spiral shape.

11. The ultraviolet sterilization device according to claim 3, wherein the transport pipe is formed in a spiral shape.

12. The ultraviolet sterilization device according to claim 9, wherein the transport pipe is formed in a spiral shape.

13. The ultraviolet sterilization device according to claim 2, comprising a plurality of the transport pipes, upstream side branch pipes which are respectively connected to inlet openings of the transport pipes, and downstream side branch pipes which are respectively connected to outlet openings of the transport pipes, wherein
a plurality of the ultraviolet light sources are provided at least at either the upstream side branch pipes or the downstream side branch pipes so that ultraviolet rays enter all of the transport pipes.

14. The ultraviolet sterilization device according to claim 3, comprising a plurality of the transport pipes, upstream side branch pipes which are respectively connected to inlet openings of the transport pipes, and downstream side branch pipes which are respectively connected to outlet openings of the transport pipes, wherein
a plurality of the ultraviolet light sources are provided at least at either the upstream side branch pipes or the downstream side branch pipes so that ultraviolet rays enter all of the transport pipes.

15. The ultraviolet sterilization device according to claim 6, comprising a plurality of the transport pipes, upstream side branch pipes which are respectively connected to inlet openings of the transport pipes, and downstream side branch pipes which are respectively connected to outlet openings of the transport pipes, wherein
a plurality of the ultraviolet light sources are provided at least at either the upstream side branch pipes or the downstream side branch pipes so that ultraviolet rays enter all of the transport pipes.

16. The ultraviolet sterilization device according to claim 9, comprising a plurality of the transport pipes, upstream side branch pipes which are respectively connected to inlet openings of the transport pipes, and downstream side branch pipes which are respectively connected to outlet openings of the transport pipes, wherein
a plurality of the ultraviolet light sources are provided at least at either the upstream side branch pipes or the downstream side branch pipes so that ultraviolet rays enter all of the transport pipes.

17. The ultraviolet sterilization device according to claim 2, wherein
an ultraviolet ray intensity measuring device which measures an intensity of ultraviolet rays which are emitted from the ultraviolet light source is provided at the transport pipe and
a control part which controls the intensity of ultraviolet rays of the ultraviolet light source based on a measured value of the ultraviolet ray intensity measuring device is provided.

18. The ultraviolet sterilization device according to claim 3, wherein
an ultraviolet ray intensity measuring device which measures an intensity of ultraviolet rays which are emitted from the ultraviolet light source is provided at the transport pipe and
a control part which controls the intensity of ultraviolet rays of the ultraviolet light source based on a measured value of the ultraviolet ray intensity measuring device is provided.

19. The ultraviolet sterilization device according to claim 6, wherein
an ultraviolet ray intensity measuring device which measures an intensity of ultraviolet rays which are emitted from the ultraviolet light source is provided at the transport pipe and
a control part which controls the intensity of ultraviolet rays of the ultraviolet light source based on a measured value of the ultraviolet ray intensity measuring device is provided.

20. The ultraviolet sterilization device according to claim 9, wherein
an ultraviolet ray intensity measuring device which measures an intensity of ultraviolet rays which are emitted from the ultraviolet light source is provided at the transport pipe and
a control part which controls the intensity of ultraviolet rays of the ultraviolet light source based on a measured value of the ultraviolet ray intensity measuring device is provided.
